(19) United States
(12) Patent Application Publication
(10) Pub. No.: US 2003/0096422 A1
(43) Pub. Date: May 22, 2003

(54) Pressurized liquid extraction method and apparatus

(76) Inventors: Eng Shi Ong, Singapore (SG); Soo On Woo, Singapore (SG); Yuk Lin Yong, Singapore (SG); Siti Norasikin Binte Apandi, Singapore (SG)

Correspondence Address: MORRISON & FOERSTER LLP, 3811 VALLEY CENTRE DRIVE, SUITE 500, SAN DIEGO, CA, 92130-2332, US

(21) Appl. No.: 09/991,151

(22) Filed: Nov. 16, 2001

(51) Int. Cl. G01N 1/18; G01N 33/00

(52) U.S. Cl. 436/91; 436/93; 436/96; 436/92; 436/128; 436/129; 436/161; 436/178; 436/173; 422/69; 422/70; 210/198.2

(57) ABSTRACT

Methods and apparatus for the solvent extraction of analytes from a sample are provided. A solvent system is used to extract analytes under elevated temperatures and constant regulated pressures under dynamic conditions. The extracted analytes may then be further analyzed.

### TECHNICAL FIELD OF THE INVENTION

The present invention relates to methods for solvent mediated extraction of organic analytes from a sample via a regulated dynamic, flow through, mode under elevated temperatures and pressures. The invention may used to extract bioactive components from simple to complex naturally occurring materials, such as, but not limited to, botanical samples. The methods may be coupled with analytical methods such as capillary electrophoresis (CE) or high performance liquid chromatography (HPLC) to provide an efficient and accurate means for the chemical standardization of analytes from a sample.

### BACKGROUND OF THE INVENTION

Multiple systems have been developed for the extraction of compounds and analytes from samples for analysis and use. The extracted compounds and analytes can be subsequently quantified, identified and characterized.

One extraction system is soxhlet extraction, which utilizes a large excess of solvent to sample ratio at high temperatures, for a period of hours to days. Variations of this system include the use of elevated temperatures (e.g. at the boiling point of the solvent).

Another system is microwave extraction, as provided in Canadian patent 1,336,968, which utilizes microwaves to heat the solvent and to provide shorter extraction times. Another example is provided in European Patent Application 0 485 668 A1, which discloses a dynamic system comprising microwave energy and utilizing an organic solvent to extract compounds from biological materials.

Solvents under supercritical conditions have also been used in extraction systems, such as that disclosed by Frank et al. in U.S. Pat. Nos. 5,094,741, 5,133,859, 5,240,603, and 5,322,626. A similar CO₂ utilizing systems are described in FR2706166 and U.S. Pat. No. 6,111,108. U.S. Pat. No. 6,001,256 disclose a supercritical system using water as the solvent. Gleave et al. (U.S. Pat. Nos. 5,660,727 and 5,785,856) disclose an apparatus for such extraction systems.

The apparatus of Gleave et al. may also be used in a manner analogous to the accelerated solvent extraction system described in U.S. Pat. No. 5,843,311 by Richter et al. Briefly, this system involves the use of an organic solvent under elevated temperatures and pressures to extract analytes of interest. The system comprises a pump (component 14 in FIG. 1) to pressurize solvent which is delivered to an extraction cell which is heated (components 20 and 25-27 in FIG. 1). The cell may be isolated by use of on/off valves in the solvent lines leading into (component 15 in FIG. 1) and away from (component 30 in FIG. 1) the cell. The valve leading away from the cell (component 30) remains closed until the pumping of solvent into the cell in combination with heating results in the desired temperature and pressure. The valve leading into the cell (component 15) is then closed and the extraction carried out under static conditions for a period of time, at the end of which the static and purge valves (components 12 and 30) are opened to send the extract to collection (component 35 in FIG. 1). The system may also be operated in a flow-through mode where component valve 30 remains open.

The use of systems similar to that of Richer et al. (U.S. Pat. No. 5,843,311) have been described and used in non-patent literature. See for example Benthin et al., Dionex Application Note 335, Ong et al., Richter et al.(1996), Richter (1999), Richter et al. (2000), Macnaughton et al., Ezzell et al., Richter et al. (2001), Bjorklund et al. Hawthorne et al., Schantz et al., Richter (2000), and Schnitzer et al..

Recently, Ong and Woo (Electrophoresis 2001, 22, 2236-2241) as well as Ong and Apandi (Electrophoresis, 22:2723-2729, 2001) described the use of a pressurized liquid extraction system wherein superheated solvent was used as part of a regulated dynamic mode to extract compounds of interest in small volumes over short periods of time. These methods provide advantages not seen with any of the previously known extraction systems.

### SUMMARY OF THE INVENTION

The present invention provides methods as well as an apparatus to extract one or more than one organic compound of interest from a sample with short extraction times. The methods and apparatus have the flexibility of being coupled with analytical methods such as capillary electrophoresis (CE), including capillary zone electrophoresis (CZE), high performance liquid chromatography (HPLC), and others to provided an efficient, accurate and environment-friendly means for the chemical standardization of analytes from a sample.

The present invention thus provides methods for use of a heated or superheated solvent for the extraction of one or more than one analyte of interest from a sample. The methods comprise extraction of a solid or semi-solid analyte containing sample in an extraction cell in contact with a non-aqueous organic solvent system at a regulated pressure or pressure range under dynamic conditions. The methods of the present invention may thus be termed regulated pressure liquid extraction, or RPLE. The solvent is subject to a heating step prior to contact with the extraction cell to maintain an elevated temperature and pressure below supercritical conditions. The extraction cell is preferably also heated. The solvent in the extraction cell remains in a liquid state (or form) under the pressure or pressure range regulated by an in-line back pressure regulator, positioned downstream, of the extraction cell. The extracted analyte is constantly extracted and removed by the continuing flow of heated and pressurized solvent moving through the extraction cell and to a collection means.

While no microwave energy is necessarily present in the methods of the present invention, the invention may optionally be practiced with the application of microwave energy.

### BRIEF DESCRIPTION OF THE DRAWINGS

FIG. 1 is a schematic representation of an apparatus for the pressurized liquid solvent extraction system of the present invention.

FIG. 2 shows chemical structures of berberine and strychnine which may be extracted from medicinal plants and herbal preparations by methods of the present invention.

FIG. 3A-3B are electrophoretic separations of standard solutions containing 1—chlorpheniramine maleate, 2—strychnine, 3—berberine and 4—yohimbine at wavelength 220 nm (FIG. 3A) and 254 nm (FIG. 3B). Running buffer was 50 mM ammonium acetate buffer at pH 3.1 using an uncoated fused silica capillary (76 cm×75 μm ID), voltage of 18 kV and temperature of 25° C.

FIG. 4A-4D are electrophoretic separations of sample extract of medicinal plants/herbal preparations containing 1—chlorpheniramine maleate (Internal standard), 2—strychnine and 3—berberine. FIG. 4A shows strychnine from strychnos nux-vomica, 4B shows berberine from rhizoma coptidis, 4C shows berberine from CPM, and 4D shows berberine from a health supplement. The running buffer was 50 mM ammonium acetate buffer at pH 3.1 using an uncoated capillary fused silica 76 cm×75 μm ID, voltage of 18 kV, temperature of 25° C.; and uv detection at 254 nm.

FIG. 5 shows chemical structures of aristolochic acids I and II which may be extracted from Radix Aristolochiae by methods of the present invention.

FIG. 6A and 6B are electropherograms of internal standard 2-naphthol, aristolochic acid I and II using 30 mM sodium tetraborate buffer at pH 9.5 (FIG. 6A) and 30 mM sodium tetraborate buffer at pH 8.4 (FIG. 6B). IS: internal standard, AI: aristolochic acid I, AII: aristolochic acid II, other conditions as stated in section 2.3.

FIG. 7A-7C are electropherograms of CPM sample LT-1 (FIG. 7A), CPM sample S3 (FIG. 7B), and medicinal plant sample radix aristolochiae (qingmuxiang) (FIG. 7C) with 30 mM sodium tetraborate buffer at pH 9.5. IS: internal standard, AI: aristolochic acid I, AII: aristolochic acid II, other conditions as stated in section 2.3.

FIG. 8A-8B are HPLC chromatograms of medicinal plant sample radix aristolochiae (qingmuxiang) (FIG. 8A) and CPM sample LT-1 (FIG. 8B). AI: aristolochic acid I, AII: aristolochic acid II, other conditions as stated in section 2.4.

### DETAILED DESCRIPTION OF THE INVENTION

The present invention provides pressurized liquid extraction methods for extracting one or more than one organic compounds from a sample of interest by use of an organic solvent system. The invention may be used to extract a diverse array of organic compounds to be used as analytes for further analysis by means such as capillary electrophoresis (CE) or high performance liquid chromatography (HPLC). The invention may thus be utilized in, or as part of, an analytical standardization protocol for determining the presence of one or more compounds in the sample.

The method (and apparatus) may also be used as a preparative means to extract one or more compounds of interest from a sample. Whether used in an analytical or preparative mode, the invention provides one or more than one extracted compound which may be further purified to provide a means for the manufacturing of a compound or compounds for further analysis, use in trials and assays, formulation of pharmaceuticals or other consumable health supplements, and other uses recognized by one skilled in the art. In one embodiment of the invention, the methods provided an efficiency and accurate means for the chemical standardization of analytes from a sample of interest.

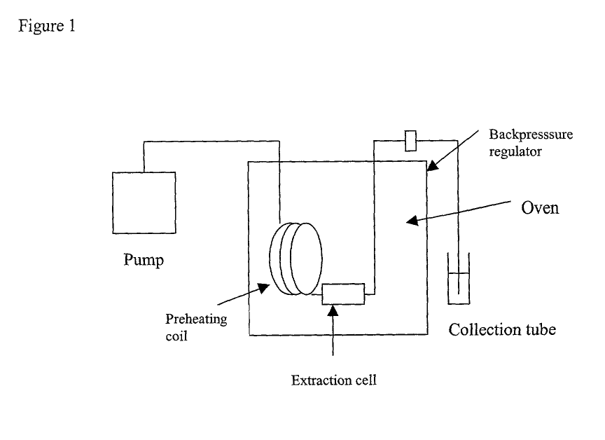

Extraction of active ingredients is an important step which can affect the accuracy of the method in the determination of analytes present naturally in medicinal plant material. In most reports, the extraction steps are often long and tedious with high solvent consumption. Regulated pressure liquid extraction (RPLE) as disclosed herein is a newer and better method compared to traditional methods of extraction such as soxhlet and ultrasonic for the extraction of target analyte in environmental samples. RPLE uses organic solvent at elevated temperature and higher applied pressure to extract samples packed in an extraction cells (FIG. 1). The applied pressure helps to force the solvent into the pores of the sample matrix and keeps the solvent in liquid state at the elevated temperature. Extraction at elevated temperatures increased the solubility, diffusion rate and mass transfer, coupled with ability of the solvent to disrupt the analyte-matrix interaction, higher extraction efficiency, significant time savings and lower solvent consumption.

One aspect of the present invention addresses the fact that the determination of active ingredients in medicinal plants is complicated by the lack of certified reference materials. The accuracy of any method is difficult to determine as spiking of the target analyte into the medicinal plant will not mimic the analyte-matrix interaction present naturally. Furthermore, the high recoveries observed in spiking experiments would not imply that the method was accurate. Additionally, determination of active ingredients in herbal preparations/CPM are more difficult as they are known to contain between 2 to 10 different types of medicinal plants. In one embodiment of the invention, a single step extraction using RPLE with no further cleanup followed by CZE for complex matrix such as medicinal plants/herbal preparations is provided.

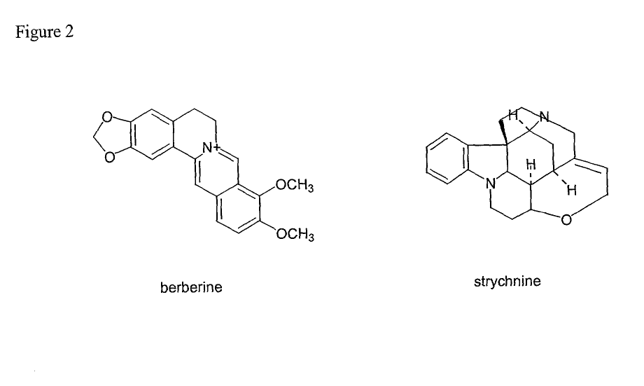

In one embodiment, the present invention may be used to extract berberine and strychnine (see FIG. 2). Berberine is a common alkaloid found in medicinal plants such as rhizoma coptidis (huang lian) and species of mahonia. It has been reported to counteract toxicity, exhibit antibacterial and antiinflammatory activity. Strychnine is found in medicinal plants such as strychnos nux-vomica/semen strychni pulveratum (maqianzi). It was reported to be a stimulus for the central nervous system, cause the sense organ to be more sensitive, simulates the visceral organs and urogenital tract. Therapeutic doses were reported to produce a tonic effect on the alimentary canal, a limited amount of respiratory and vasomotor simulation. However, the margin between useful and dangerous doses is very narrow as it was reported to be fatal to man at doses of 30 to 90 mg. Due to berberine's therapeutic value and strychnine's toxicty, the determination of both components in medicinal plant, chinese prepared medicine (CPM) and health supplements are of importance.

The chinese pharmacopeia includes a method for the analysis of berberine in medicinal plants using extraction with methanol on a water bath at 60° C., sonication for 30 minute and allowed to stand overnight with final analysis by TLC [1]. Multiple step ultrasonic extraction has been used to extract berberine in medicinal plants and related herbal preparations with analysis by HPLC and HPLC/MS respectively. Similarly, berberine in medicinal plants or CPM products are determined using ultrasonic extraction with CZE [2, 3, 4, 5] and CE-ESI-MS [6].

The assay of strychnine in medicinal plants in the chinese pharmacopeia included a 24 hour extraction step with final determination by spectrophotometry [1]. Others report extracting strychnine in medicinal plant by ultrasonic extraction with analysis by CZE.

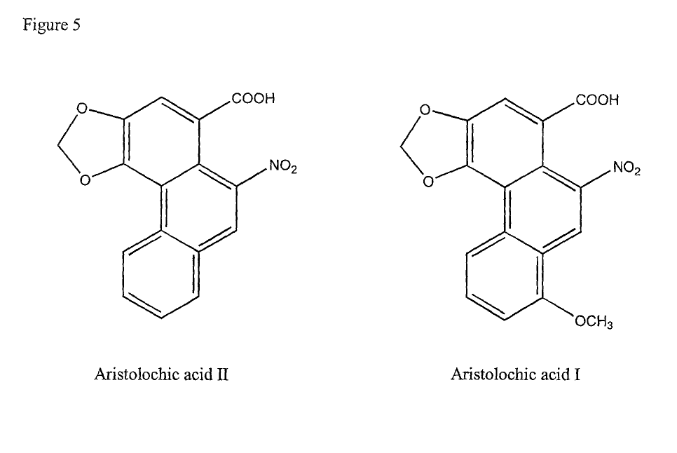

Aristolochic acids I and II (FIG. 5) are found naturally in medicinal plants such as radix aristolochiae and has been identified as chinese herb nephropathy. The pharmacopoeia of the People's Republic of China indicated it can be used to relieve pain by subdueing hyperactivity of the liver, counteract toxicity and cause subsidence of swelling. Additionally, it has also been reported to relieve pain and induce diuresis. Recent interests in the analysis of aristolochic acids in medicinal plants arises from various reports about their carcinogenic effect as well as cases of unexplained end stage renal failure. This has led to calls to have tighter control on medicinal plants containing aristolochic acids.

Aristolochic acids present in medicinal plants or herbs have been analyzed by soxhlet extraction followed by TLC in the chinese pharmacopoeia. Others report using multiple step ultrasonic extraction followed by analysis by HPLC. However, analysis of aristolochic acids in chinese prepared medicine (CPM) by HPLC presented great difficulty using a single step extraction as it was well known that CPM contained multiple herbs or medicinal plants. The chromatograms obtained from CPM samples by HPLC were too complex for identification of aristolochic acids. We found that a two step solvent partition was required which will result in high solvent consumption, formation of emulsion as well as tedious sample preparation step.

CE is a powerful alternative to HPLC in the analysis of polar and thermally labile compounds. In one embodiment of the invention, aristolochic acids present in medicinal plants or CPM were extracted using a single step RPLE with methanol as solvent. The accuracy and specificity of the method was checked either by comparison with HPLC or standard addition experiments.

A sample as used herein is a solid or semi-solid material containing the compounds of interest and to be extracted. As noted above, one or more than one of the compounds of interest may be an analyte of interest, such as, but not limited to, by being a pharmaceutically active compound; a toxic substance, a contaminant or impurity in the source material sampled; or an additive to the sample. The compound may optionally be the major or main component of the sample. For example, non-limiting compounds from medicinal plants; herbal preparations; food products; aquatic samples including fish or shellfish; waste materials, sediments or sludges; soils; or animal and plant tissues such as leaves, cellulosic products, roots, and bark may all be extracted by use of the present invention. Contaminants or impurities in samples of medicinal products, foods, and industrial reagents may also be extracted. Concentrations, in absolute or relative terms, of the main or major components of various samples may also be extracted.

An extracted compound/analyte of the invention are preferably organic, or generally more soluble in organic or non-aqueous solvents than in water or other aqueous solvents. They are also preferably bioactive. The compounds/analytes include, but are not limited to, berberine, aristolochic acids, strychnine, ginsenosides, glycyrrhizin, baicalein, other compounds of the Chinese Phamacopoeia or other Pharmacopoeia monographs, food additives, vitamins, other pharmaceutical compounds, drugs, hormones, lipids, (organophosphorus) pesticides, herbicides, polychlorinated biphenyls (PCBs), polycyclic aromatic hydrocarbons (PAHs), gasoline components, triglycerides, phenols, aldehydes, alcohols, lipids, waxes, nitrosamines, phthalates, halogenated esters, hydrocarbons, chlorinated hydrocarbons, heterocyclic compounds, phosphates, acids, bases, polymer additives, or mixtures thereof.

In one embodiment of the invention, the samples contain solid particles obtained from a source material of interest by cutting, scraping, crushing, grinding, pulverizing and/or other sampling means known in the art. The sample is preferably free of substantial amounts of liquid, especially water or other aqueous fluids. Preferably, the water content in the sample should be less than about 5-50, and preferably less than about 20 w/w. Water in the sample should be minimized to improve sample penetration by the solvent used for extraction. Most samples may nevertheless be extracted without dehydration treatment, although a drying step may be optionally practiced in combination with the present invention. If a drying step, including but not limited to heat treatment, evaporation, or treatment with desiccants such as acetone or ethanol, the destruction or loss of volatile analytes should be minimized.

Samples that are composed of fine particulates are more likely to improve penetration and channeling of the solvent through the sample to result in better extraction. During preparation of the sample, excess heating should be minimized to prevent loss of volatile analytes or otherwise changing the amounts or chemical nature of the analytes. The samples may also optionally be spiked with one or more than one known compound, preferably in known quantities or concentrations, as an internal reference standard for the extraction process or the extraction profile.

The organic solvent used in the present invention is preferably substantially non-aqueous or otherwise consists mainly of organic solvent. The term “substantially non-aqueous” or equivalents herein refers to solvents or mixtures of solvents that do not contain an appreciable amount of any aqueous solvent such as, but not limited to, water. For example, the solvent system will comprise less than about 15%, less than about 10%, less than about 5%, or no more than about 0% (or no more than trace amounts) water.

A diverse range of organic solvents and combinations thereof may be utilized in the present invention. The choice of solvent system depends on the analyte to be extracted and the nature of the sample as well as the skill and experience of the practitioner. On non-limiting example is on the basis of a solvent's Hildebrand solubility parameters (see for example Giddings et al., Science 162:67-73 (1968)) Other non-limiting examples include the polarity index, the dielectric constant, the dipole moment, or the eluotropic value on alumina, of a solvent.

Suitable solvent classes include, but are not limited to, C₁-C₆ alcohols, halogenated hydrocarbons, saturated hydrocarbons, aromatic hydrocarbons, ketones, ethers, alcohol ethers, nitrogen-containing heterocyclics, oxygen-containing heterocyclics, esters, amides, sulfoxides, carbonates, aldehydes, carboxylic acids, nitrites, nitrated hydrocarbons and acetamides.

The organic solvent or combination used in the present invention preferably has an average viscosity in the range of about 0.20 to about 4.20 cps at 25° C. Preferred embodiments utilize a solvent or combination with a viscosity range of about 0.2 to about 1.0 cps at 25° C. The most preferred range is between about 0.20 to about 0.65 cps at 25° C. If the solvent used is a single solvent, the skilled artisan can calculate the change in viscosity of the solvent at various temperatures using, for example, the equations and graph shown in Perry's Chemical Engineers' Handbook, 6th Edition, Ed. R. Perry, page 3-281. If the solvent system comprises two or more solvents, the average viscosity of the mixture at 25° C. is determined using techniques known in the art, and then the change in viscosity as a function of temperature is calculated.

Mixtures of solvents will contain at least two, 2-4, 4-6, 6-8, or 8-10 solvents. The solvents may include, but are not limited to, perchloroethylene, iso-octane (also called trimethylpentane), hexane, acetone, methylene chloride, toluene, methanol, chloroform, ethanol, tetrahydrofuran, acetonitrile, methyl ethyl ketone, pentane, N-methylpyrrolidone, cyclohexane, dimethyl formamide, xylene, ethyl acetate, chlorobenzene, methoxyethanol, morpholine, pyridine, piperidine, dimethylsulfoxide, ethoxyethanol, isopropanol, propylene carbonate, petroleum ether, diethyl ether, dioxane, and mixtures thereof.

The solvent used may also contain one or more additives to increase the solvent strength of a solvent. The additives may also be selected to minimize ionization of one or more than one analyte of interest. This results in the analyte being more soluble in the organic solvent. Preferred additives include, but are not limited to, trifluoroacetic acid, citric acid, acetic acid, trimethyl amine, and tetramethyl ammonium hydroxide.

The selection of the solvent(s) to be used in the extraction of an analyte of interest may be made by any means known in the art or the skill of the artisan. For example, if the sample and/or the analyte has a standard extraction procedure known in the art, the same solvent system may be used in the present invention. As a non-limiting example, the Environmental Protection Agency (EPA) has numerous accepted protocols for the analysis of certain analytes and/or samples such as soils and sludges. These protocols set forth suitable solvents to use for particular analytes.

Alternatively, the chemical characteristics of the analyte may be used in determining a suitable solvent system. Analytes which are known to be soluble in a particular solvent or mixture of solvents may be extracted using that solvent system. Typically, the solubility of an analyte in the solvent system should be at least about 0.001 gm/ml to about 0.5 gm/ml, although solubilities of more than about 1 gm/ml as well as lower solubilities may be acceptable. In preferred embodiments of the invention, the solubility of an analyte is about 0.005, about 0.01, about 0.05, or about 0.1 gm/ml.

For a sample containing one or more unknown analytes, the choice of a suitable solvent may be made in a variety of ways. The sample may be divided up and extracted using different solvents, such as a non-polar solvent, a slightly polar solvent and a highly polar solvent. A determination of the best solvent for a particular analyte may be made by comparison to known extraction profiles. Alternatively, a sample may be repeatedly extracted using different solvents, and the extracted analytes compared. This is usually performed sequentially using a series of solvents with a uni-directional change in a particular characteristic. An example is the sequential use of a non-polar, a slightly polar, and a highly polar solvent.

Extraction with a selected solvent or solvent mixture is performed by the present invention as exemplified by the apparatus shown in FIG. 1. Briefly, a pump is operably linked to an extraction cell, comprising a sample compartment which may be contacted by solvent moving through the cell, such that the pump may be used to deliver the solvent to said extraction cell containing the sample to be extracted. Said extraction cell comprises an input connector which is attached to the solvent line leading from the pump to the extraction cell. The solvent line leading from the pump is contacted with a preheating element, such as a heating coil, or otherwise heated to bring the solvent to the desired temperature prior to contact with the sample. The heated solvent proceeds through the extraction cell and leaves it through an output connector which is attached to a solvent line leading away from the extraction cell. The heated solvent proceeds under a dynamic mode through a backpressure regulator, which is operably linked to the extraction cell via said solvent line and output connector, and then to a collection means. The backpressure regulator is thus capable of regulating the pressure of the solvent in the extraction cell to keep the solvent in a liquid state as it dynamically contacts the sample in the extraction cell. As used herein, “operably linked” refers to a physical arrangement between components that permit them to function in their intended ways in an RPLE apparatus of the invention.

In one preferred embodiment of the invention, the extraction cell and solvent line leading from the pump are maintained in a heating assembly capable of heating said extraction cell and said solvent line (and optionally a preheating element in contact with said solvent line). One non-limiting example of such a heating assembly is an oven.

As used herein, “regulate” or “regulated” refers to the directing and/or controlling of the solvent pressure in the RPLE method and apparatus of the invention. Preferably, this pressure is “regulated” to be at a constant pressure or within a particular range of pressures. The pressure is thus not permitted to vary beyond a set point (or limit) or beyond a set range. While this may be accomplished by a variety of means, one non-limiting means is by directing, controlling and/or adjusting the amount, rate, and/or flow of solvent in the RPLE method and apparatus of the invention.

The method of the invention proceeds generally as follows. First, the extraction cell is loaded with sample to be extracted. The sample contains the analyte or analytes of interest. In a preferred embodiment, the sample fills the cell, that is, the dead volume of the cell is 10% or less. Compression or expansion of the sample during extraction may occur to change the dead volume. The void volume of the sample may be higher than 10% to permit penetration of the solvent. The size of the extraction cell is thus preferably selected to allow the sample to fill the cell completely. Suitable extraction cells have volumes of about 0.1 ml to about 50 ml, with about 0.5, about 1, about 2, about 5, about 10, and about 15 ml extraction cells being preferred. Other sizes may also be used. The extraction cells are of course composed of materials which allow the use of the solvents, pressures and temperatures of the invention. Suitable extraction usually have frits of some type to retain the sample in the cell, as will be appreciated by those skilled in the art.

Alternatively, the sample does not fully fill the volume of the extraction cell, and an inert filler is used. In some cases, inert fillers may be mixed into the sample if it is highly compressible, which can lead to clogging of the system. Suitable inert fillers include solid (particulate) substances which do not contain extractable materials, such as sand, diatomaceous earth or glass wool. Other inert fillers are known by the skilled artisan.

Once the extraction cell is loaded with sample, it is attached via its inlet and outlet to be in the solvent line between the pump and the collection means. Preferably, the extraction cell is contacted with the solvent and placed within a preheated oven or heating block and allowed to equilibrate to the oven or block temperature. Alternatively, the extraction cell may be exposed to preheated solvent immediately after placement in the oven or heating block. Preheating of the solvent is necessary to generate the appropriate pressure in the system as outlined below. Extraction proceeds in a dynamic, flow through mode.

Pressures used will depend on the particular solvents and samples of the run; for example, samples with high levels of extractable materials generally require less pressure. Suitably, the pressure ranges from about 10 bar to about 30 bar. Preferably, the range is from about 10 to about 20 or about 20 to about 30 bar. The backpressure regulator may be set to prevent the pressure from exceeding a set upper limit. When used in combination with the temperature setting, the backpressure regulator may constrain the pressure in the system to be within a certain range and/or no more than an upper limit of interest. The adjustable backpressure regulator can also be used to reduce the pressure buildup in the system when it exceeds a set point.

The temperature used in the present invention is from about 100 to about 200 degrees Celsius, more preferably from about 100 to about 120, about 120 to about 140, about 140 to about 160, about 160 to about 180, and about 180 to about 200 degrees Celsius. In particularly preferred embodiments of the invention, the temperature is at or about 100, at or about 120, at or about 140, at or about 150, at or about 160, at or about 180, or at or about 200 degrees Celsius. As with the pressure used, the exact temperature used will depend on the solvent(s) and the nature of the analyte(s) and sample.

The temperatures and pressures used in the method of the present invention are below supercritical conditions. Stated differently, the solvent systems are in liquid form prior and during extraction, and maintained in that state by the backpressure regulator. The solvent(s) thus remains liquid even if the temperature is above the boiling point of the solvent(s).

The extraction is conducted for a period of time with a constant flow rate of solvent(s) from the pump. Preferably, the time is sufficient for extraction of the analyte(s) of interest and/or about 20 minutes and the flow rate is at or about 1 ml/min. Alternatively, higher flow rates, ranging from about 0.1 to about 5 ml/min, such as but not limited to about 0.2, about 0.5, about 1.5, about 2, about 3, or about 4 ml/min may be used for times ranging from about 5, about 6, about 7, about 8, about 9, about 10, about 15, about 20, about 25, about 30, about 35, about 40, about 45, about 50, about 60, about 90, about 100, about 120, about 150, about 180 or about 200 minutes.

As well appreciated in the art, and generally observed, the faster the flow rate, the less efficient the extraction. Higher flow rates may be appropriate, however, for larger extraction cells or samples with large quantities of compound/analyte. Slower flow rates may be used to increase the degree of extraction or with samples containing small amounts of compound/analyte.

The time used for extraction may be chosen in several ways, and will depend in part on the purpose of the extraction. For example, a less efficient extraction, shorter time period, may be used if qualitative identification is the goal. A more complete extraction, longer time period may be used if quantitation or yield of the analytes is critical.

Preferably, the extraction is run such that not more than about 20%, and preferably not more than 10%, more of the analyte or analytes will be subsequently extracted in a subsequent extraction using the same method or other extraction methods such as accelerated solvent extraction, soxhlet or microwave extraction. The time of extraction is thus selected to extract about 80-90% of the extractable material from the sample. Generally, as outlined above, this time ranges from about 5 to about 200 minutes. One measure of adequate extraction is that no more than about a further 10% of the compounds/analytes are extracted by maintaining the same extraction conditions for an additional equivalent time period. As recognized by the killed artisan, sample extraction may be discontinuous, so the time factor is the total time of extraction.

Preferably, the sample is not dissolved during extraction, but rather the analytes removed. The conditions of the reaction are thus designed to avoid the complete or substantial dissolution of a solid sample. However, solid samples containing significant amounts of extractable material may show a decrease in mass as a result of the extraction of the analytes.

Preferably, the extraction is run in the absence of microwave energy although microwaves may be used in combination with the present invention, included as part of the extraction process.

Once the extracted compounds/analytes are collected, they may be subjected to further analysis. This may be done by any means known in the art and depending on whether identification or quantification of the analytes or both is of interest. The selection of analytical means also depends on the composition of the analytes. The compounds/analytes may be left in the solvent(s), or the solvent(s) removed, as part of the analysis. The analytes may be analyzed using techniques well known in the art, including, but not limited to, gas chromatography, mass spectrometry, ion chromatography, liquid chromatography or capillary electrophoresis. In addition, the solvent(s) containing the compounds/analytes may be concentrated prior to analysis, for example by inert gas blow-down or evaporation. If the concentration of compounds/analytes is high, they may also be diluted prior to analysis.

The following examples are put forth so as to provide those of ordinary skill in the art with a complete disclosure and description of how to make and use the present invention, and are not intended to limit the scope of what the inventors regard as their invention nor are they intended to represent that the experiments below are all and only experiments performed. Efforts have been made to ensure accuracy with respect to numbers used (e.g. amounts, temperature, etc.) but some experimental errors and deviations should be accounted for. Unless indicated otherwise, parts are parts by weight, molecular weight is weight average molecular weight, temperature is in degrees Celsius, and pressure is in bar.

### EXAMPLES

### Example 1

### Materials and Methods

All reagents were of analytical grade. Berberine chloride, strychnine free base and chlorpheniramine maleate were purchased from Sigma (St. Louis, Mo., USA). Methanol was purchased from Hayman (Witham, Essex, England). Sand purified by acid (about 40 to 100 mesh) and sodium tetraborate (Borax) were purchased from BDH Chemical Ltd (Poole, England). Acetic acid and ammonium acetate of were purchased from Merck (Darmstadt, Germany) and Hayashi (Osaka, Japan). Pure water was obtained from Millipore Alpha-Q water system (Millipore, Bedford, Mass., USA). Aristolochic acids I (69%) and II (19%) was purchased from Sigma (St. Louis, Mo., USA). 2-naphthol was obtained from Merck (Darmstadt, Germany).

For analyzing berberine and strychnine, the running buffer used for CZE analysis consists of 50 mM ammonium acetate, adjusted to pH 3.1 using acetic acid. For optimization experiments, buffers containing 40, 50 and 60 mM ammonium acetate at pH 3.1 were prepared. Buffer solutions were filtered prior to use through 0.45 μm membrane filters. Stock solutions of berberine chloride, strychnine at 200 mg/l and internal standard chlorpheniramine maleate at 1000 mg/l were prepared in methanol respectively. For all analysis, the working solutions of berberine and strychnine were prepared in the range of 0 to 30 mg/l with 40 mg/l of chlorpheniramine maleate in 10% aqueous methanol.

For analyzing aristolochic acids, the running buffer used for CZE analysis consists of 30 mM sodium tetraborate, set at pH 9.5 using 1.0 M NaOH. For optimization experiments, buffers containing 25, 30, 40 and 50 mM sodium tetraborate at pH 9.5 were prepared. Buffer solutions were filtered prior to use through 0.45 μm membrane filters. Stock solutions of aristolochic acids and internal standard 2-napthol at 200 mg/l and 1200 mg/l were prepared by dissolving in methanol respectively. For all analysis, the working solution were diluted in the range of 0 to 30 mg/l for aristolochic I and from 0 to 10 mg/l for aristolochic II with 25 mg/l of 2-napthol in methanol.

Analysis was carried out using a CE/L1 capillary electrophoresis system (CE Resources, Singapore) equipped with a Shimadzu SPD-10A UV detector. Data was collected and interpreted using CSW chromatographic station (DataApex Ltd, Czech Republic). Separation was done using a 75 μm ID uncoated fused silica capillary column (Supelco, Bellefonte, USA) with an effective length of 35 cm (total length, 76 cm). For berberine and strychnine, detection was at 254 nm, oven was set at 25° C. and the system was operated at 18 kV in the constant voltage mode. Standard and sample solutions were injected hydrodynamically for 10 s at pressure 0.3 psi. For aristolochic acids, detection was at 254 nm, oven with forced air cooling was set at 25° C. and the system was operated at 15 kV in the constant voltage mode with anode at the injection end. Standard and sample solutions were injected hydrodynamically for 10, 15 and 20 seconds respectively at pressure 0.3 psi. In all analyses, the capillary was flushed with 0.1 M NaOH followed by distilled water and running buffer for 5 minutes respectively, prior to analysis. To avoid adsorption, the capillary was washed with 0.1 M NaOH for 3 minutes, followed by water for 2 minutes and the running buffer for 4 minutes in between runs.

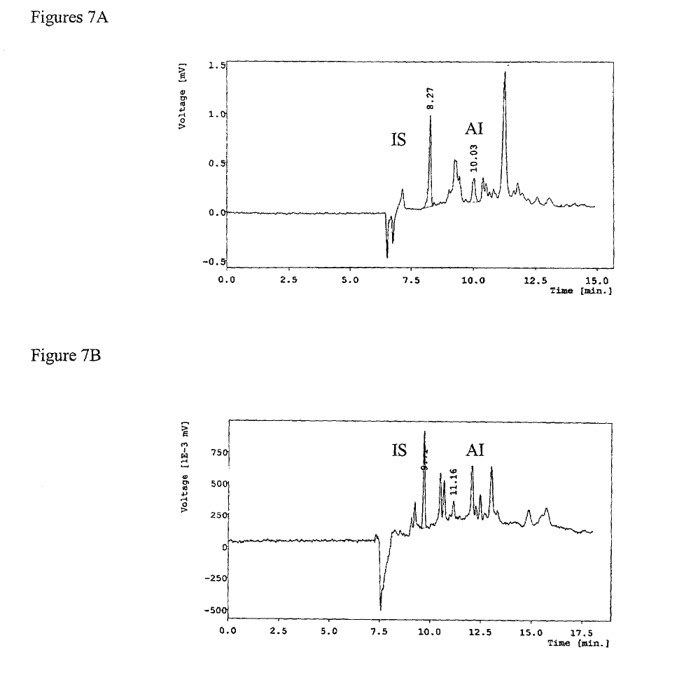

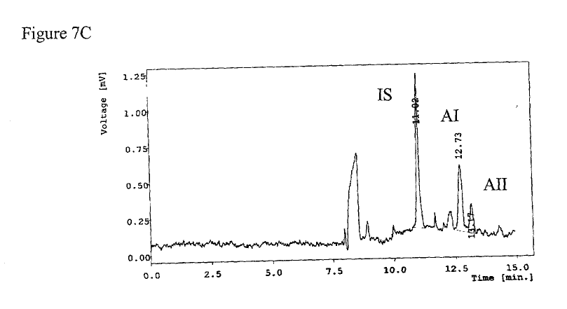

For all aristolochic acid related experiments, a Shimadzu LC 10 series (Kyoto, Japan) equipped with a binary gradient pump, autosampler, column oven and diode array detector was used. For aristolochic acid, gradient elution with mobile phase consisting of A) 1% acetic acid in water and B) methanol was used. The initial condition was set at 40% of B and gradient up to 100% B in 15 minutes before returning to initial condition. Detection was at 254 mn and 310 nm. Oven temperature was set at 40° C. and flow rate was set at 1.0 ml/min. For all experiments, 20 μl of standards and sample extract were injected. The column used for separation was Hypersil Elite (Runcorn, Cheshire, England) C18 (250×4.6 mm ID, 5 μ). Examples of electropherograms of CPM samples are shown in FIGS. 7A-7C.

### Example 2

### Berberine and Strychnine Analyses: Sample Preparation for RPLE and Soxhlet Extraction

Strychnos nux-vomica was in the form of seeds and rhizoma coptidis was in the form of roots. The health supplement sample came in the form of capsules and the CPM sample was in the form of black pills. To prepare a homogenous sample, the strychnos nux-vomica, rhizoma coptidis and the CPM samples were ground using an IKA MF10 microfine grinder (Staufen, Germany) with sieve insert of hole size 0.5 mm. For the health supplement sample, content of 30 capsules were emptied into a container to prepare a homogenous sample. Depending on the level of strychnine and berberine present in the sample, 0.1 to 1.0 g of samples were weighed directly into the extraction cell as shown in FIG. 1. The extraction cells were finally filled with sand to avoid any voids.

FIG. 1 is a schematic of the RPLE system used in this work. The stainless steel tubings used were 1/16 inch OD and 0.18 mm ID. The back pressure was generated using a back pressure regulator by VICI Jour Research (Onsala, Sweden). The extraction cells for berberine and strychnine were of stainless steel with 10 mm ID×100 mm (7.85 ml). The extraction cells for aristolochic acids were of stainless steel with 4.6 mm ID×150 mm (2.50 ml) and 10 mm ID×100 mm (7.85 ml). The extraction cell was heated in a HP5890, gas chromatograph oven (Hewlett Packard, USA). The pump used was a ternary gradient HP1050 HPLC pump (Hewlett Packard, Waldbronn, Germany). The pump flow was set at 1.0 ml/min and the oven temperature was set at 120° C. The pressure in the system indicated by the HPLC pump was between 25 to 30 bar.

For berberine and strychnine, the extraction cell was prefilled with methanol to check for possible leakage before setting the temperature of the oven to the required value. Extraction with methanol was carried out for a period of 20 minutes and 20 to 25 ml of solvent was collected into a 25 ml volumetric flask. In between runs, the system was washed with methanol. Finally, 1 to 4 ml of the sample extracts were pipette into a 5 ml volumetric flask followed by addition of 40 mg/l of chlorpheniramine maleate as internal standard and diluted with 10% aqueous methanol. For standard addition experiments, 1 to 4 ml of sample extract was pipette into a 5 ml volumetric flask, berberine and strychnine standard solution at 4 levels in the range of 0 to 20 mg/l were added with 40 mg/l of chlorpheniramine maleate as internal standard.

For aristolochic acids, 0.5 to 1.0 g of sample was weighed into the extraction cell and packed with sand. The extraction cell was prefilled with methanol to check for possible leakage before setting the temperature of the oven to the required value. Extraction with methanol was carried out for a period of 20 minutes and 20 to 25 ml of solvent was collected into a 25 ml volumetric flask. In between runs, the system was washed with methanol. Finally, 1 to 4 ml of the sample extracts were pipette into a 5 ml volumetric flask followed by addition of 25 mg/l of 2-napthol as internal standard. For standard addition experiments, depending on the amount of aristolochic acids present in the sample analyzed, 1 to 4 ml of sample extract was pipette into a 5 ml volumetric flask. Aristolochic acids standard solution at 4 levels in the range of 0 to 20 mg/l were added with 25 mg/l of 2-napthol as internal standard.

For soxhlet extraction, 0.1 to 1.0 g of medicinal plant/herbal preparation samples were weighed into the thimble. The co-extract gave a yellow color with the extraction solvent. The yellowish color turned lighter and lighter through the course of the extraction. Hence, after extraction with 100 to 120 ml of methanol for seven to eight hours, the extraction solvent was essentially colorless. The excess solvent was evaporated under a gentle stream of nitrogen with gentle heating. The extracts were finally transferred into a 50 or 100 ml volumetric flask. Finally, 1 to 4 ml of the sample extracts were pipetted into a 5 ml volumetric flask followed by addition of 40 mg/l of chlorpheniramine maleate as internal standard and diluted with 10% aqueous methanol. All extracts were filtered through a 0.45 μm membrane filter (Target) before analysis by CE.

### Example 3

### Optimization of Berberine and Strychnine Separation by CZE

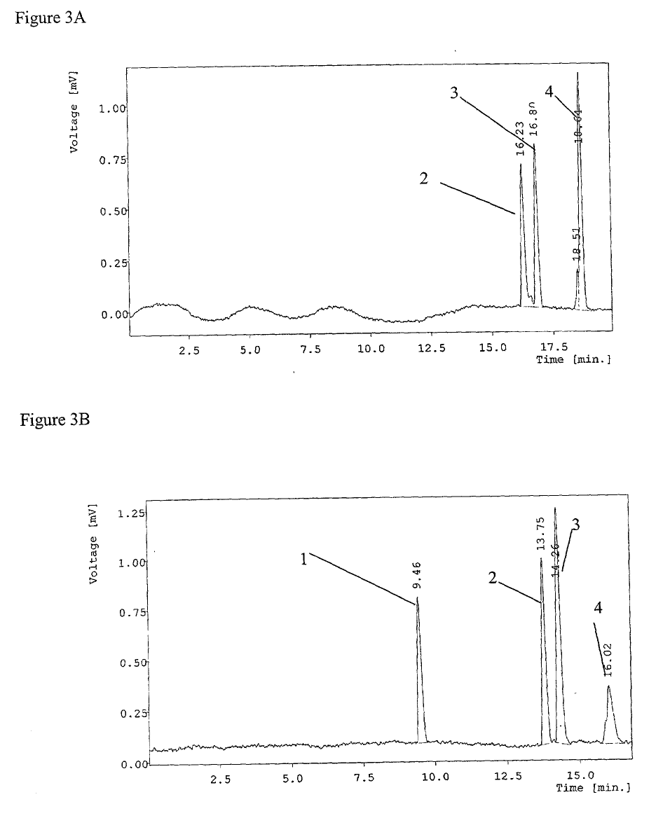

Ammonium acetate was selected as the buffer as it was commonly available, volatile and used in reported works which allowed the method to be used for CE-MS eventually [3, 6]. Chlorpheniramine maleate was used as internal standard as it was a substance that was not present naturally in medicinal plant or CPM as well as it migrates ahead of berberine, strychnine and their related alkaloids. Initially, yohimbine was used as internal standard with monitoring at wavelength 220 nm. It was found that yohimbine co-elutes with some of the related components in the medicinal plants analyzed. The baseline movement (FIG. 3A) was larger at lower wavelength compared to at 254 nm which was possibly due to the standards and sample extracts were prepared in 10% aqueous methanol and the strong absorption of acetate buffer. Hence, the electrophoretic separation was monitored at 254 nm.

The factors that will affect electrophoretic separation include ionic strength, pH, buffer types, organic modifiers and others. All these factors are known to affect the robustness of method which is an important parameter in method validation. Effects of different concentrations of ammonium acetate at 40, 50 and 60 mM at pH 3.1 were investigated, and it was found that the migration time was slower with buffer at higher concentration. The electrophoretic separation of berberine, strychnine and chlorpheniramine maleate was not affected drastically by a small change in the buffer concentration even though berberine and strychnine migrated close to each other (FIG. 3B). As for pH, experiments with 50 mM acetate buffer adjusted to pH at 3.1, 3.5 and 4.0 were investigated. In the same way, the resolution of the three components was not affected by a small change in the pH. However, at pH 4.0, the migration time for the three components were less reproducible compared to at pH 3.1. Organic modifiers such as acetonitrile or methanol were added to the buffer in some reports [3, 4, 5, 6], our experiments found that the addition of organic modifiers will not affect the resolution of the three components. Based on our results and the aim was to use an aqueous running buffer, no organic modifiers were added.

It was observed in our laboratory and other reports [10, 11] that run failures were encountered in CZE and MEKC where standard solutions were prepared in high percentage of methanol. The effect was due to a disruption of the conductivity inside the capillary caused either by the presence of a non-conductivity plug or the result of the out-gassing in the injection zone. As the sample was extracted with methanol, 10% water in methanol was added to standard solutions and sample extracts to counter run failures.

The results in the optimization experiments showed that a small change in the operating conditions would not affect the separation of the components of interest.

Linearity for berberine and strychnine was established between 0 to 25 mg/l (correlation coefficient≧0.99). The LOD for berberine and strychnine calculated based on three times the standard error of the intercept was 1.86 and 2.06 mg/l respectively. The proposed mode of electrophoretic separation was validated for reproducibility for the relative migration time and peak area of analytes using chlorpheniramine maleate as internal standard. The relative standard deviation (RSD) values of the relative migration time for berberine was observed to vary from 0.79 to 0.87% (n=6) and strychnine from 0.72 to 0.80% (n=6) on three different days. For peak area, the RSD values of 6 replicates on 3 different days for berberine at concentrations between 7.0 to 9.0 mg/l were found to vary from 0.9 to 2.5%. Strychnine at concentrations between 8.0 to 10.0 mg/l were found to vary from 0.8 to 2.6%.

### Example 4

### Optimization of RPLE

The parameters that affect the extraction efficiency in RPLE include the solvent type, time of extraction/volume of solvent required and temperature for extraction. Methanol was selected as the extraction solvent for strychnine as it was reported that 1 gram of it dissolves in 260 ml methanol, 35 ml boiling alcohol and 5 ml chloroform [12]. On top of that, methanol was known to be more environmentally friendly compared to chloroform, which is also used as an extraction solvent. If necessary to overcome the lower solubility of strychnine in methanol, the amount of sample used was adjusted in a way that it was way below the saturation point.

The extraction efficiency of strychnine in medicinal plant by RPLE at different temperature with 20 ml of methanol were tabulated in Table 1 (which used a 20 minute extraction period and a 20 ml volume of solvent). It was found that the extraction efficiency increased drastically when the temperature was increased from 80 to 140° C. This was unique for strychnine as it was observed in previous work that the effect of temperature on the extraction efficiency of berberine and aristolochic acids in the medicinal plants analyzed did not vary drastically from 100 to 120° C. As the amount of strychnine was determined using external calibration, higher variation in the results was observed at 120 and 140° C. With these data, the temperature for RPLE was set at 130° C. The time of extraction/volume of solvent collected was based on our earlier report that a significant amount of target analyte was extracted in the first 25 ml of solvent.

TABLE 1
Amount of strychnine extracted with RPLE at different temperatures

| | Amount of Strychnine found in Strychnos |
|---|---|
| Temperature of RPLE (° C.) | nux-vomica (mg/kg) |
| 80 | 1090.9 |
| 100 | 1655.4 |
| 120 | 4629.2 |
| 140 | 3954.8 |

To determine the extraction efficiency of RPLE, the amount of strychnine in the same medicinal plant was compared with that obtained by soxhlet extraction with methanol as solvent. The results were tabulated in Table 2. The amount of strychnine in the medicinal plant by RPLE was significantly higher than that obtained by soxhlet extraction. In the same way, the extraction efficiency of berberine in the CPM and health supplement samples by RPLE was comparable or higher than soxhlet extraction.

TABLE 2
Comparison of RPLE with soxhlet extraction for strychnine and
berberine and other medicinal products

| | PLE (n = 2) | Soxhlet extraction (n = 2) |
|---|---|---|
| Strychnine in strychnos | 3511.23 | 2253.53 |
| nux-vomica (mg/kg) | | |
| Berberine in health | 3456.27 | 3472.22 |
| supplement as capsules | | |
| (mg/kg) | | |
| Berberine in CPM as black | 61.79 | 53.51 |
| pills (mg/kg) | | |

### Example 5

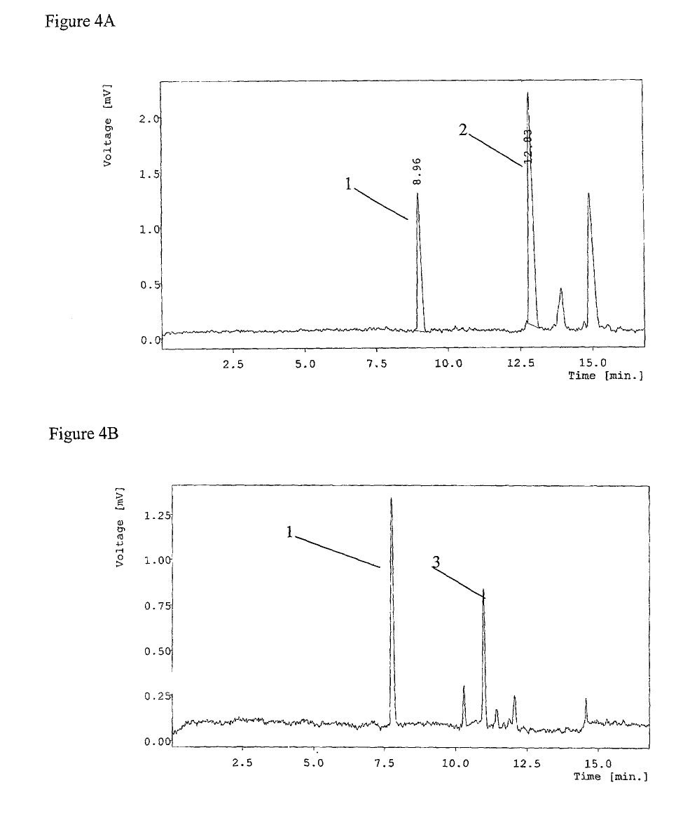

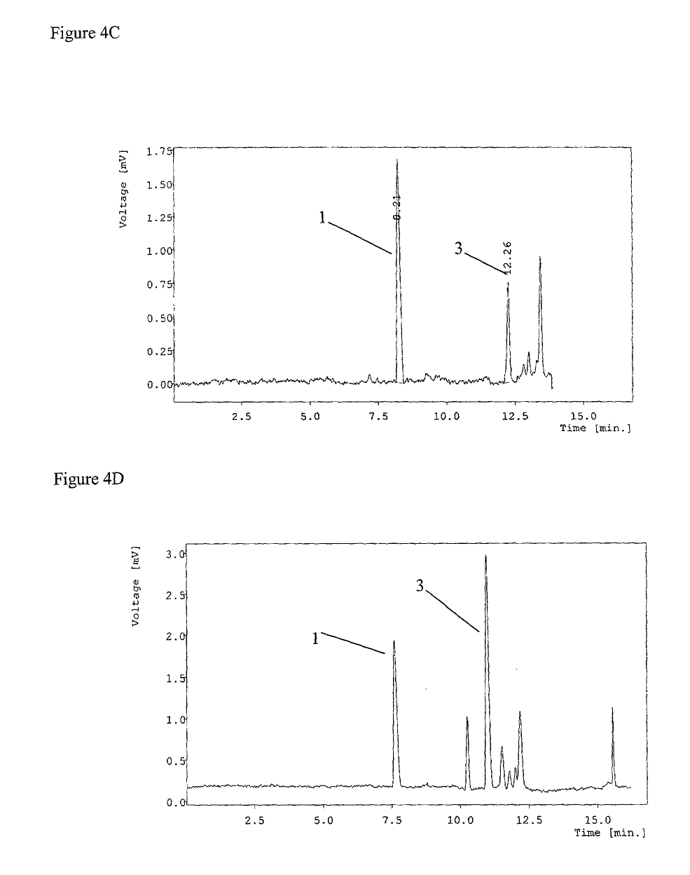

The reproducibility of RPLE with CZE was found to vary between 2.4 to 10.7% as shown in Table 3 for different types of samples (FIGS. 4A-4D) on different days. In one of the medicinal plant samples (rhizoma coptidis), the accuracy of the method was checked based on the content of berberine determined by CZE with comparison to that obtained by HPLC. The specificity of the HPLC method was checked by comparing the uv spectra obtained in the sample extract and the berberine standard used. The results in Table 3 show that good method accuracy and precision was achieved for analysis by CZE compared to HPLC. Higher variation was observed for berberine in the CPM sample as the sample may not be homogenous and quantitation was performed near to the limit of detection. The RSD values of the relative migration time of 6 replicates for berberine and strychnine in the sample extracts were observed to vary from 0.35 to 1.28% on different days. The results obtained showed the reproducibility of the relative migration time in sample extract was comparable to that in standard solution.

TABLE 3
Analysis of RPLE extraction of strychnine and berberine with CZE

| | | | RSD of relative |
|---|---|---|---|
| | | RSD, % | migration time, |
| | Content (mg/kg) | (n = 5-6) | (n = 6) % |
| Strychnine in strychnos | 4277.1 ± 101.3 | 2.4 | 0.99 |
| nux-vomica | | | |
| Berberine in rhizoma | 85271.4 ± 2487.9 | 2.9 | 0.75 |
| coptidis | | | |
| Berberine in rhizoma | 83670.3 ± 1658.8 | 2.0 | — |
| coptidis by HPLC* | | | |
| Berberine in health | 3456.3 ± 231.3 | 6.6 | 1.28 |
| supplement as capsules | | | |
| Berberine in CPM as | 61.8 ± 6.6 | 10.7 | 0.35 |
| black pills | | | |

*Data from ref. [9].

The specificity and potential matrix effects of the method by CZE were investigated by performing standard addition experiments on the few samples analyzed. The ratio of slopes by external calibration and standard addition in Table 4 was near to one showed that significant matrix effects were not observed for the medicinal plants/herbal preparation samples containing berberine and strychnine. The amount of berberine and strychnine calculated from external calibration and standard addition in Table 4 were comparable showed that significant matrix interference were not present. The results demonstrate the possibility of the analysis of active ingredients in medicinal plants or herbal preparations using a single step extraction with CZE.

TABLE 4
Comparison of berberine and strychnine content from plant samples
and other products by external calibration and standard addition

| | Ratio of | Content by | Content by |
|---|---|---|---|
| | slope from external | external | standard |
| | calibration/ | calibration | addition |
| | standard addition | (mg/l) | (mg/l) |
| Berberine in | 0.95 | 3.95 | 3.88 |
| rhizoma coptidis | | | |
| Berberine in health | 1.02 | 4.65 | 4.67 |
| supplement as | | | |
| capsules | | | |
| Berberine in CPM | 1.24 | 2.14 | 2.45 |
| as black pills | | | |
| Strychnine in | 0.96 | 16.49 | 15.34 |
| strychnos nux- | | | |
| vomica | | | |

### Example 6

### Analysis of Aristolochic Acids

Running buffer consisting of sodium tetraborate at different ionic strength (25, 30, 40 and 50 mM) at pH 9.5 were prepared. The mobilities of aristolochic acids I & II and 2-napthol decreased with an increased in the ionic strength of the running buffer. The efficiency and resolution of aristolochic acids I and II were not drastically affected by the ionic strength of the running buffer. However, the 2-napthol peak was distorted and the peak area/height of aristolochic acids I and II was significantly lower when running buffer of higher ionic strength (50 mM borate buffer) was used. Additionally, reproducibility of the peak area/height of aristolochic acids was poor in 40 to 50 mM borate buffer compared to 30 mM borate buffer. A running buffer of 30 mM of sodium tetraborate was used for further experiments.

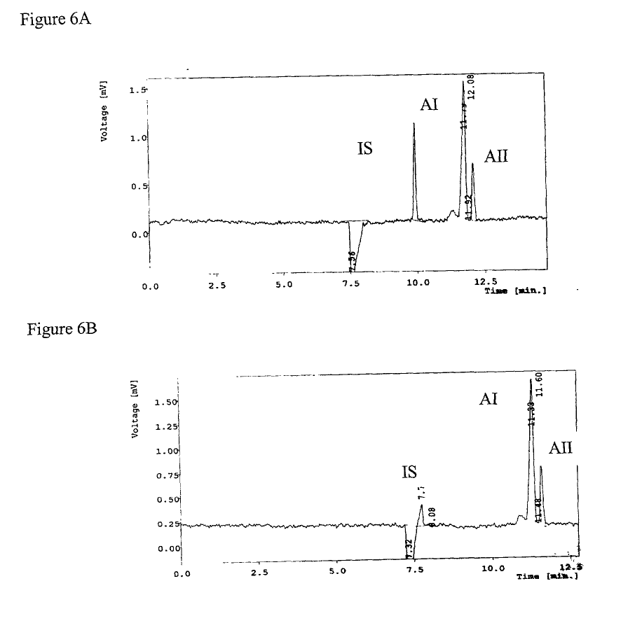

The effect of pH on the electrophoretic separation of the three components was investigated by adjusting the pH of 30 mM running buffer between 8.4 to 9.8. The efficiency and resolution of aristolochic acids I and II were not changed at different pH. However, as shown in FIGS. 6A-6B the mobility of 2-napthol increased with lower pH and finally migrated together with the EOF at pH 8.4. The applied voltage was varied from 15, 18 and 20 kV with 30 mM borate buffer at pH 9.5, the resolution and efficiency was not significantly affected. Similarly, a higher applied voltage increased the mobility of all the three components. A slight drawback of using 2-napthol as internal standard was that in a dilute solution, the compound was found to decompose when left to stand overnight. The data showed that any slight change in the pH of running buffer, ionic strength and applied voltage will not affect the separation of the three components drastically.

### Example 7

### Analysis of Aristolochic Acids: CE System Precision, Limit of Detection and Linearity

The linearity of aristolochic acid I and II were found to be in the range from 0 to 36.45 mg/l (correlation coefficient≧0.99) and 0 to 10.04 mg/l (correlation coefficient≧0.99) respectively using a 10 s hydrodynamic injection at 0.3 psi. The limit of detection (LOD) calculated based on 3 times the standard error of the y intercept for aristolochic acids I and II were found to 1.2 mg/l and 0.9 mg/l respectively. The method's LOD based on 1 g of sample extracted was found to be 30 mg/kg and 22.5 mg/kg respectively. The LOD can be improved two fold by using a 20 second hydrodynamic injection at 0.3 psi. The proposed method of estimating LOD was found to be more convenient as it uses the results from the least square calibration where human bias was not involved. Compared to using three times the ratio of the signal over noise, a section of the electrophoregram has to be selected by the analyst for the calculation of the standard deviation of the noise.

The precision data for the relative migration time and peak area or peak height of aristolochic acids I and II were tabulated in Table 5. The RSD values for the relative migration time were found to be from 0.10 to 0.17% for aristolochic acid I and II at different concentration levels with 10 or 20 second hydrodynamic injection at 0.3 psi. As for peak area or peak height, RSD values were found to vary from 2.6 to 2.8% and 3.1 to 4.2 for aristolochic acid I and II respectively. The precision data showed it is possible to inject a higher volume of standard solution in methanol with borate buffer to improve the sensitivity of the method based on sample stacking. The data demonstrates that the proposed method using 100% methanol for standard solution and sample extract was a convenient approach as no solvent exchange was required.

TABLE 5
Precision Data (RSD, %) for relative migration time (RRT) and
peak area/height of aristolochic standards (n = 5/6) by CZE

| | Concentration | Relative | Peak area/ |
|---|---|---|---|
| | (mg/l) | migration time | height |
| Aristolochic acids I* | 22.6 | 0.16 | 2.8 |
| Aristolochic acid II* | 6.22 | 0.12 | 3.1 |
| Aristolochic acids I** | 2.80 | 0.10 | 2.6 |
| Aristolochic acids II** | 0.77 | 0.17 | 4.2 |

*Standard solution was injected hydrodynamically for 10 s at pressure 0.3 psi.
**Standard solution was injected hydrodynamically for 20 s at pressure 0.3 psi, other conditions same as stated in section 2.3

### Example 8

### Applications to Medicinal Plants and CPM Samples

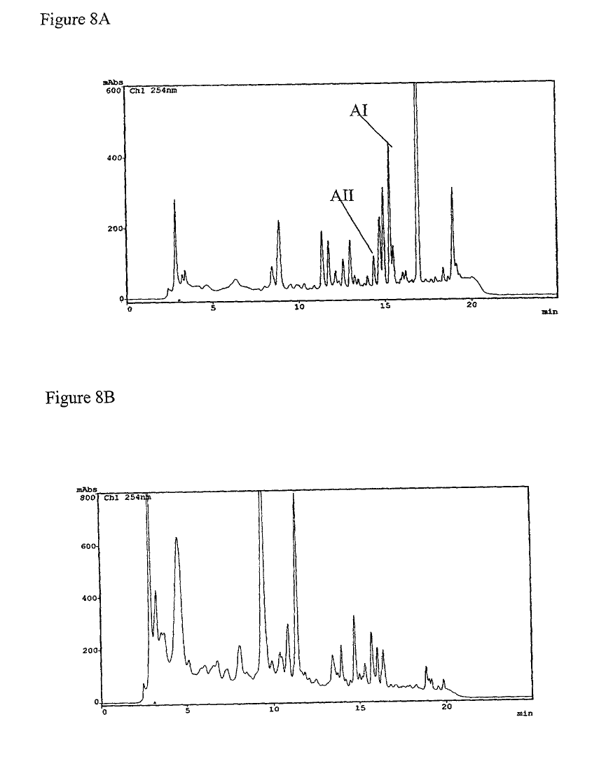

In previous work, we found that it was not possible to determine aristolochic acids in CPM samples using a single step RPLE with HPLC due to the matrix complexity as shown in FIGS. 8A-8B. A two step solvent partition was required to clean up the sample extract before it can be analyzed by HPLC.

Separation by CZE differs from HPLC as it is mainly based on the different electrophoretic mobility of charged solutes in solution in relation to their different molecular weight, size and charge at a given pH. It is also possible for both cations and anions to be separated in a single run which provide specific selectivity for the separation method. Under the conditions used for aristolochic acids, it was found that most of the positively charged and neutral species migrate close or with the EOF.

The specificity of the proposed method in medicinal plants using the same extract was checked by comparing the amount of aristolochic acids determined by CZE with that obtained by HPLC (FIG. 8A). The peak purity of aristolochic acid I and II by HPLC was checked by comparing the diode array spectra of the standard and medicinal plant extracts as described in an earlier report [2]. The results in Table 6 show that the results were comparable except in one of the medicinal plant where the values for aristolochic acid II was much higher for that obtained by CZE.

TABLE 6
Comparison of results obtained for aristolochic acids I and II
in medicinal plants by CZE and HPLC

| | Results obtained | Results obtained |
|---|---|---|
| | by CZE (ppm) | by HPLC (ppm) |
| Aristolochic acid I in radix | 541.3 | 479.8 |
| aristolochiae fangchi | | |
| Aristolochic acid II in radix | 314.6 | 57.0 |
| aristolochiae fangchi | | |
| Aristolochic acid I in radix | 612.0 | 564.1 |
| aristolochiae fangchi* | | |
| Aristolochic acid I in radix | 654.9 | 567.6 |
| aristolochiae (qingmuxiang) | | |
| Aristolochic acid II in radix | 190.0 | 208.4 |
| aristolochiae (qingmuxiang) | | |

*analysis done with different batches of radix aristolochiae fangchi
Standard and sample solution was injected hydrodynamically for 15 s at pressure 0.3 psi, other conditions same as stated in section 2.3

CZE was applied to a number of CPM samples (FIGS. 8A-8B) and the specificity of the method was checked using standard addition experiments. The data in Table 7 show that the amount of aristolochic acid I in CPM samples determined by external calibration was comparable with that by standard addition and significant matrix interference was not observed. The data obtained demonstrate the unique nature of CZE separation which provided an online cleanup step for sample with complex matrix.

TABLE 7
Standard addition experiments for the CPM samples by CZE

| | Ratio of slopes | Amount of | Amount of |
|---|---|---|---|
| | for external | aristolochic acid I | aristolochic acid |
| | calibration to | by external | I by standard |
| | standard addition | calibration (ppm) | addition (ppm) |
| CPM S3 | 0.70 | 25.9 | 23.8 |
| CPM KW-3 | 0.91 | 250.3 | 210.1 |
| CPM LT-1 | 0.89 | 580.3 | 551.6 |
| Unknown herb | 1.02 | 863.3 | 823.2 |

Standard and sample solution was injected hydrodynamically for 15 s at pressure 0.3 psi, other conditions same as stated above.

Lastly, the precision of the method using RPLE followed by CZE was determined using a medicinal plant and CPM samples. The RSD, % in Table 8 was found to be less than 4% and this value was comparable with that using RPLE with HPLC that was found to be between 2.3 to 3.1%. Similarly, The precision data (RSD, %) for the relative migration time for aristolochic acids I and II in a sample matrix were found to less than 0.3%. The values were comparable to that obtained by the standards as shown in Table 5.

TABLE 8
Method precision (RSD, %) of aristolochic acid I
in medicinal plant and CPM sample by CZE

| | Relative migration | Amount of | |
|---|---|---|---|
| | time (RSD, %) | aristolochic acids I | RSD, % |
| | N = 6 | (ppm) | N = 6 |
| radix aristolochiae | 0.12 | 612.0 ± 23.2 | 3.8 |
| fangchi | | | |
| CPM LT-1 | 0.23 | 579.9 ± 18.6 | 3.2 |

Standard and sample solution was injected hydrodynamically for 15 s at pressure 0.3 psi, other conditions same as stated above.

### REFERENCE

1) Pharmacopoeia of the People's Republic of China, English Edition, The Pharmacopeia Commission of PRC, Beijing, 1997

2) Liebich, H. M., Lehmann, R., Stefano, C. D., Haring, H. U., Kim, J. H., Kim, K. R., J. Chromatogr. A 1998, 795, 388-393

3) Liu, Y. M, Sheu, S. J., J Chromatogr. 1993, 639, 323-328

4) Li, Y., Ji, X., Liu, H., Yan, Y., Li, J., Chromatographia 2000, 51, 357-361

5) Ji, X., Li, Y., Liu, H., Yan, Y., Li, J., Pharmaceutica Acta Helvetiae 2000, 74, 387-391

6) Chen, Y. R., Wen, K. C., Her, G. R., J Chromatogr. A 2000, 866, 273-280

7) Richer, B. E., Jones, B. A., Ezzell, J. L, Porter, N. L., Avdalovic, N., Pohl, C., Anal. Chem. 1996, 68, 1033

8) Bjorklund, E., Nilsson, T., Bwadt, Trends in Anal. Chem. 2000, 19, 434-445

9) Ong, E. S., Woo, S. O., Yong, Y. L., J. Chromatogr A. 2000, 904, 57-64

10) Kelly, M. A., Altria, K. D., Clark, B. J., J. High Resol. Chromatogr. 1998, 21, 193-196

11) Kelly, M. A., Altria, K. D., Clark, B. J., J. High Resol. Chromatogr. 1999, 22, 55-58

12) The Merck Index, 11th Edition, Merck & Co., Inc., Rahway, 1989

All references cited herein, including patents, patent applications, and publications, are hereby incorporated by reference in their entireties, whether previously specifically incorporated or not, for all purposes. Citation of any reference herein is not intended as an admission that any of the foregoing is pertinent prior art, nor does it constitute any admission as to the contents or date of these documents.

Having now fully described this invention, it will be appreciated by those skilled in the art that the same can be performed within a wide range of equivalent parameters, concentrations, and conditions without departing from the spirit and scope of the invention and without undue experimentation.

While this invention has been described in connection with specific embodiments thereof, it will be understood that it is capable of further modifications. This application is intended to cover any variations, uses, or adaptations of the invention following, in general, the principles of the invention and including such departures from the present disclosure as come within known or customary practice within the art to which the invention pertains and as may be applied to the essential features hereinbefore set forth.

We claim:

1. A method for solvent extraction of analytes from a sample, said method comprising,
dynamically contacting an analyte containing sample in an extraction cell with a preheated solvent extraction fluid under elevated temperatures and regulated pressures within a specified range or at a specified value to non-selectively extract said analytes from said sample, said solvent system being in liquid form under the conditions of temperature and pressure and during extraction.

2. The method of claim 1 wherein said solvent comprises one or more than one organic solvent.

3. The method of claim 2 wherein said solvent comprises at least two organic solvents.

4. The method of claim 1 wherein said regulated pressure is from about 10 to about 30 bar.

5. The method of claim 1 wherein said temperature is from about 100 to about 200 degrees Celsius.

6. The method of claim 1 wherein the pressure is below about 30 bar.

7. The method of claim 1 wherein said sample fills said extraction cell.

8. The method of claim 1 wherein said extraction cell is full of a mixture comprising the sample and an inert filler.

9. The method of claim 1 wherein the contact with solvent occurs for between about 5 and about 200 minutes.

10. The method of claim 1 wherein the contact with solvent occurs for about 20 to about 25 minutes.

11. The method of claim 1 wherein, after about 20 or 25 minutes of contact with solvent no more than about 10% more of said analytes can be extracted in said method for an additional 20 minutes.

12. The method of claim 1 wherein the solvent is methanol.

13. The method of claim 1 wherein the sample is selected from a botanical or herbal preparation.

14. The method of claim 1 wherein said solvent comprises one or more organic solvents selected from the group consisting of perchloroethylene, isooctane, hexane, acetone, methylene chloride, toluene, methanol, chloroform, ethanol, tetrahydrofuran, acetonitrile, methyl ethyl ketone, pentane, N-methylpyrrolidone, cyclohexane, dimethyl formamide, xylene, ethyl acetate, chlorobenzene, methoxyethanol, morpholine, pyridine, piperidine, dimethylsulfoxide, ethoxyethanol, isopropanol, propylene carbonate, petroleum ether, diethyl ether, dioxane, and mixtures thereof.

15. The method of claim 1 wherein said solvent contains an additive.

16. The method of claim 15 wherein said additive is selected from trifluoroacetic acid, citric acid, acetic acid, trimethyl amine, and trimethyl ammonium hydroxide.

17. The method of claim 1 wherein said analytes include at least one analyte selected from aristolochic acids, berberine, and strychnine.

18. The method of claim 1 wherein no microwave energy is used.

19. The method of claim 1 further comprising detection of said analytes.

20. The method of claim 1 wherein the dynamically contacting is at a flow rate of about 1 ml/min solvent.

21. The method of analyzing analytes extracted from a sample comprising the method of claim 1 further comprising analysis of said analytes by a technique selected from the group consisting of gas chromatography, mass spectrometry, ion chromatography, liquid chromatography and capillary electrophoresis.

22. An apparatus for dynamic extraction of analytes from a sample with a heated solvent comprising
an extraction cell capable of containing said sample and containing a solvent line input connector and a solvent line output connector for solvent lines,
a heating assembly capable of heating said extraction cell and the solvent line in contact with said input connector,
a pump linked to said extraction cell via said input connector and capable of delivering solvent to said cell, and
a backpressure regulator linked to said cell via said output connector and capable of regulating pressure in said cell.

23. The apparatus of claim 22 wherein said heating assembly comprises a preheating coil in contact with said solvent line in contact with said input connector.

24. The apparatus of claim 22 further comprising a collection means for extracted analytes.

25. The apparatus of claim 22 wherein said solvent comprises one or more than one solvent.

26. The apparatus of claim 22 wherein said solvent comprises at least two organic solvents.

27. The apparatus of claim 22 wherein said backpressure regulator limits pressure in said extraction cell to be from about 10 to about 30 bar.

28. The apparatus of claim 22 wherein said extraction cell is maintained at a temperature from about 100 to about 200 degrees Celsius.

29. The apparatus of claim 22 wherein the solvent is methanol.

30. The apparatus of claim 22 wherein the sample is selected from a botanical or herbal preparation.

31. The apparatus of claim 22 wherein said solvent comprises one or more organic solvents selected from the group consisting of perchloroethylene, isooctane, hexane, acetone, methylene chloride, toluene, methanol, chloroform, ethanol, tetrahydrofuran, acetonitrile, methyl ethyl ketone, pentane, N-methylpyrrolidone, cyclohexane, dimethyl formamide, xylene, ethyl acetate, chlorobenzene, methoxyethanol, morpholine, pyridine, piperidine, dimethylsulfoxide, ethoxyethanol, isopropanol, propylene carbonate, petroleum ether, diethyl ether, dioxane, and mixtures thereof.

32. The apparatus of claim 22 wherein said solvent contains an additive.

33. The apparatus of claim 32 wherein said additive is selected from trifluoroacetic acid, citric acid, acetic acid, trimethyl amine, and trimethyl ammonium hydroxide.

34. The apparatus of claim 22 wherein said analytes include at least one analyte selected from aristolochic acids, berberine, and strychnine.

35. The apparatus of claim 22 wherein said pump delivers solvent at a flow rate of about 1 ml/min solvent.
